(19) United States
(12) Patent Application Publication
(10) Pub. No.: US 2005/0243786 A1
(43) Pub. Date: Nov. 3, 2005

(54) Method for transceiving data in coordinator-based wireless network and wireless network device employing the same

(75) Inventors: Dae-gyu Bae, Suwon-si (KR); Hyun-ah Sung, Seoul (KR); Jin-woo Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/107,951

(22) Filed: Apr. 18, 2005

(30) Foreign Application Priority Data
Apr. 22, 2004 (KR) 10-2004-0027854
Mar. 24, 2005 (KR) 10-2005-0024447

(51) Int. Cl. H04Q 7/24

(52) U.S. Cl. 370/338

(57) ABSTRACT

A method for transceiving data in a coordinator-based wireless network and a wireless network device employing the same are provided. The method for transmitting data in a coordinator-based wireless network, includes providing data to be transmitted to another wireless network device in the coordinator-based wireless network, providing a Media Access Control (MAC) frame containing the data and type information indicating the type of the data and conforming to a protocol for the coordinator-based wireless network, and transmitting the MAC frame to the other wireless network via a wireless medium. The method enables inter-operation between an MAC layer and a layer above the MAC layer by specifying type information in an MAC frame.

### CROSS-REFERENCE TO RELATED APPLICATIONS

This application claims priority from Korean Patent Application Nos. 10-2004-0027854 and 10-2005-0024447 filed on Apr. 22, 2004 and Mar. 24, 2005, respectively, in the Korean Intellectual Property Office, the disclosures of which are incorporated herein by reference in their entirety.

### BACKGROUND OF THE INVENTION

1. Field of the Invention

Apparatuses and methods consistent with the present invention relates to a data transceiving, and more particularly, to transceiving data in a coordinator-based wireless network.

2. Description of the Related Art

With the advancement in communication and network technologies, a wired network environment using wired media such as coaxial or optical cables is evolving into a wireless one using wireless signals in various frequency bands. In line with the transition from wired to wireless technology, a computing device (hereinafter, referred to as wireless network device) that contains a wireless interface module, enables mobility, and perform specific functions by processing various information is being developed. In addition, wireless network technologies have emerged, which allow such wireless network devices to efficiently communicate with each other.

Generally, a wireless network may be classified into the following two types of networks.

As shown in FIG. 1, one type of wireless network includes an access point 110, and is called an infrastructure mode wireless network.

Further, as shown in FIG. 2, another type of wireless network does not include an access point, and is called an ad-hoc mode wireless network.

In the infrastructure mode wireless network, an access point 110 performs a relay function of transmitting data in order to connect a wireless network to a wired network or communication between wireless network devices belonging to a wireless network. Accordingly, all data must pass through the access point 110.

Next, the ad-hoc mode wireless network is formed only when a network is required without an advance plan. In the ad-hoc mode wireless network, wireless network devices belonging to a single wireless network directly exchange data with each other without passing through a connecting device such as the access point.

The ad-hoc mode wireless network may be classified into two types of networks. In a first network type, a wireless network device designated randomly from among wireless network devices belonging to a single wireless network functions as a coordinator which assigns a time period (hereinafter, referred to as a “channel time”), for which data can be transmitted, to the other wireless network devices. Further, the other wireless network devices can transmit data only for a assigned channel time. In a second network type, there is no wireless network device functioning as a coordinator, and all wireless network devices can transmit data whenever they are wanted to transmit data.

Herein, in the case of the former, that is, in the network type (hereinafter, referred to as a coordinator-based wireless network) in which a wireless network device functioning as a coordinator exists, an independent single wireless network is formed on the basis of the coordinator. Further, when a plurality of coordinator-based wireless networks exist in a predetermined area, each of the coordinator-based wireless networks has inherent identification information in order to be distinguished from other coordinator-based wireless networks. Accordingly, wireless network devices belonging to a specific coordinator-based wireless network can exchange data with other wireless network devices in the specific coordinator-based wireless network for a channel time period determined by a coordinator.

In a conventional coordinator-based wireless network technology, research is focusing on a Media Access Control (MAC) layer corresponding to a Data-link Layer of the Open System Interconnection (OSI) network model. However, the conventional technology did not consider a layer above the MAC layer. Thus, when an MAC layer of a coordinator-based wireless network protocol is connected to a layer above it to provide a wider array of and more efficient network designs, there is difficulty in interworking between the MAC layer and an upper layer.

### SUMMARY OF THE INVENTION

The present invention provides a method and apparatus for transceiving data in a coordinator-based wireless network by specifying type information in an MAC frame.

According to an aspect of the present invention, there is provided a method for transmitting data in a coordinator-based wireless network, including: providing data to be transmitted to another wireless network device in the coordinator-based wireless network; providing an MAC frame containing the data and type information indicating the type of the data and conforming to a protocol for the coordinator-based wireless network; and transmitting the MAC frame to the other wireless network via a wireless medium.

According to another aspect of the present invention, there is provided a method for receiving data in a coordinator-based wireless network, including receiving an MAC frame conforming to a protocol for the coordinator-based wireless network via a wireless medium in the coordinator-based wireless network, checking type information representing the type of data contained in the MAC frame using the MAC frame, and providing the data to a protocol of an upper layer identified through the type information.

According to still another aspect of the present invention, there is provided a wireless network device including an upper layer module providing data to be transmitted to another wireless network device in a coordinator-based wireless network, a frame processing module providing an MAC frame containing data provided by the upper layer module and type information indicating the type of the data and conforming to a protocol for the coordinator-based wireless network, and a transceiving module transmitting the MAC frame provided by the frame processing module through a wireless medium.

According to a further aspect of the present invention, there is provided a wireless network device including a transceiving module receiving an MAC frame conforming to a protocol for a coordinator-based wireless network via a wireless medium in the coordinator-based wireless network, and a frame processing module checking type information representing the type of data contained in the MAC frame using the MAC frame received by the transceiving module and providing the data to a protocol of a layer above an MAC layer, which is identified through the type information.

### BRIEF DESCRIPTION OF THE DRAWINGS

The above and other aspects of the present invention will become more apparent by describing in detail exemplary embodiments thereof with reference to the attached drawings in which:

FIG. 1 is an exemplary diagram of a wireless network operating in an infrastructure mode;

FIG. 2 is an exemplary diagram of a wireless network operating in an ad-hoc mode;

FIG. 3 illustrates a stack structure defined in the IEEE 802.15.3 standard;

FIG. 4 is a stack structure according to an exemplary embodiment of the present invention;

FIG. 5 illustrates the format of an MAC frame according to an exemplary embodiment of the present invention;

FIG. 6 illustrates the format of an MAC frame according to another exemplary embodiment of the present invention;

FIG. 7 is a block diagram of a wireless network device according to an exemplary embodiment of the present invention;

FIG. 8 is a flowchart illustrating a method for transmitting data in a coordinator-based wireless network according to an exemplary embodiment of the present invention; and

FIG. 9 is a flowchart illustrating a method for receiving data in a coordinator-based wireless network according to an exemplary embodiment of the present invention.

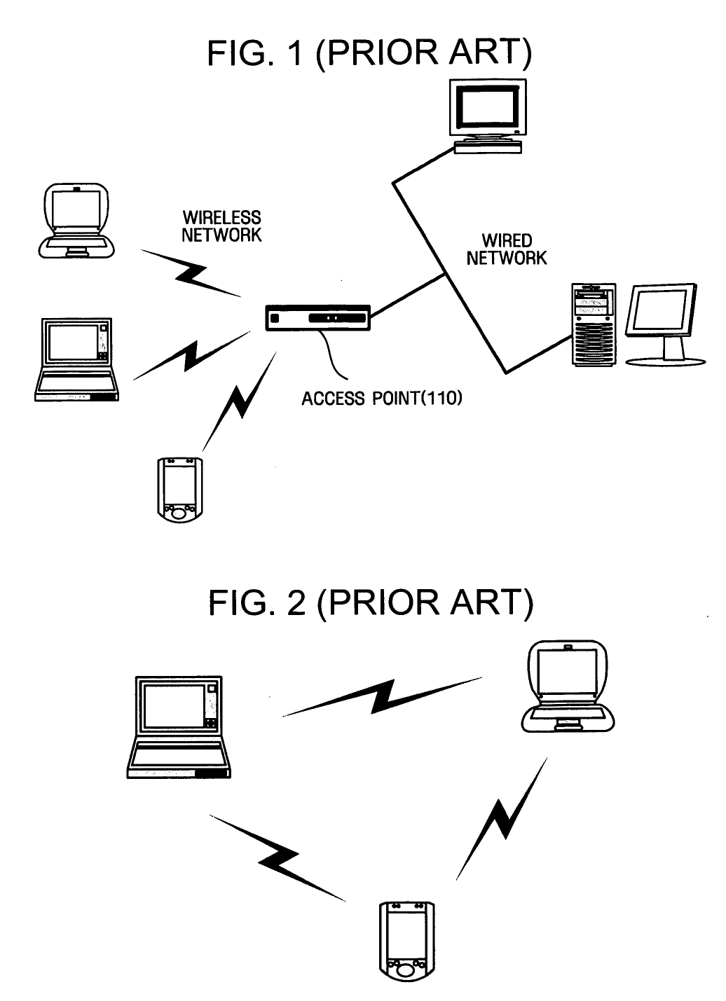

### DETAILED DESCRIPTION OF EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

In the present invention, as described above, a coordinator-based wireless network means an ad-hoc wireless network, in which a randomly selected wireless network device acts as a coordinator that assigns channel time to other wireless network devices within the same wireless network for data transmission, and then the other wireless network devices are allowed to transmit data only at the assigned time.

In a representative example of a coordinator-based wireless network, the Institute of Electrical and Electronics Engineers (IEEE) 802.15.3 proposes standards for an MAC layer making up a Data-Link Layer among the seven layers of the Open System Interconnection (OSI) network model developed by the International Organization for Standardization (ISO) for wireless networks.

Thus, to aid in understanding of the present invention, an IEEE 802.15.3 coordinator-based wireless network will now be described with reference to the attached drawings.

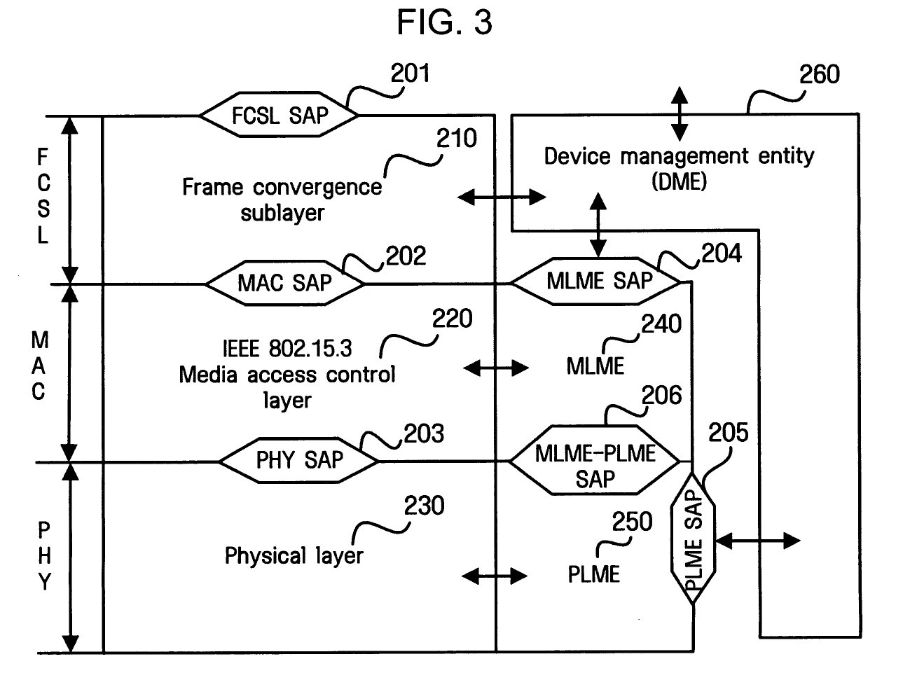

First, referring to FIG. 3, an IEEE 802.15.3 stack structure will be briefly described. An MAC layer 220 and a Physical (PHY) layer 230 have layer management entities called an MAC layer management entity (MLME) 240 and a PHY layer management entity (PLME) 250, respectively. The management entities provide service interfaces through which layer management functions are performed in each layers.

A device management entity (DME) 260 is also present to provide services that allow precise operation to be performed at the MAC layer. The DME 260 operating independently of each layer gathers layer-dependent status from the layer management entities and sets layer-specific parameters.

Service access points (SAPs) act as gates that route information between layers or management entities. For example, information is transferred between the PHY layer 230 and the MAC layer 220 and between the MAC layer 220 and a Frame Convergence Sublayer (FCSL) 210 through a PHY SAP 203 and an MAC SAP 202, respectively. Information is exchanged between the DME 260 and the MLME 240 and between the DME 260 and the PLME 250 via a MLME SAP 204 and a PLME SAP 205, respectively. Furthermore, information is exchanged between the MLME 240 and the PLME 250 and between the FCSL 210 and a layer (not shown) immediately above it via a MLME-PLME SAP 206 and a FCSL SAP 201, respectively.

Meanwhile, to allow for a wider array of and more efficient network designs, the IEEE 802.15.3 stack structure of FIG. 3 needs to be connected systematically to a layer (i.e., a Network Layer of the OSI seven layer model) that may reside above it.

To aid in understanding of the present invention, it will now be described by explaining an example in which an internetwork layer of the Transmission Control Protocol/Internet Protocol (TCP/IP) protocol suite reside directly above the stack structure of FIG. 3.

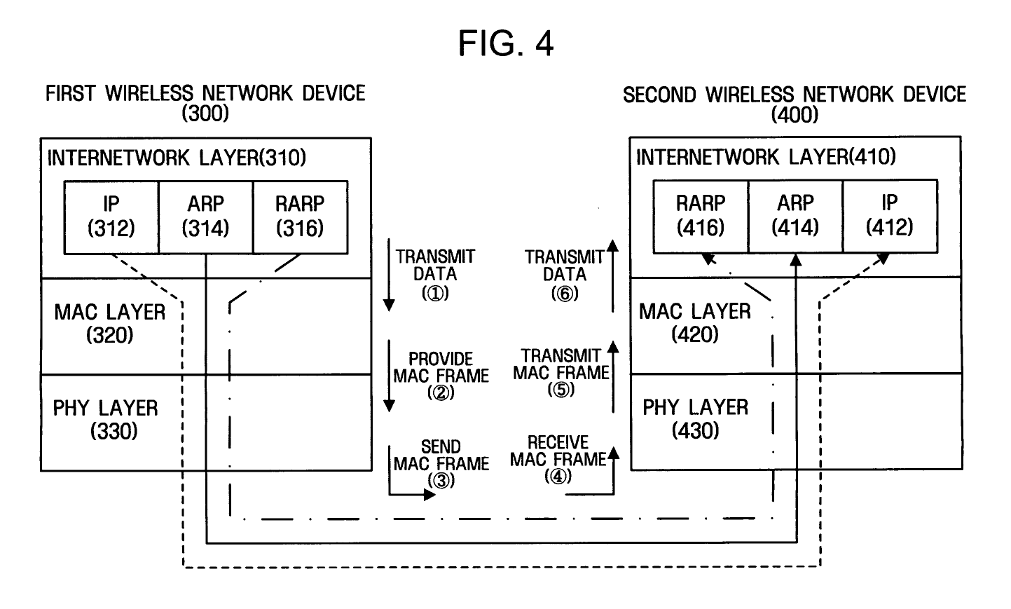

FIG. 4 illustrates a stack structure in a wireless network device according to an exemplary embodiment of the present invention.

Referring to FIG. 4, stack structures of first and second wireless network devices 300 and 400 respectively include internetwork layers 310 and 410 in addition to the conventional IEEE 802.15.3 stack structure. In the present exemplary embodiment, the internetwork layer 310 of the first wireless network device 300 supports three protocols, an IP 312, an address resolution protocol (ARP) 314, and a reverse address resolution protocol (RARP) 316. The internetwork layer 410 of the second wireless network device 400 also supports an AP 412, an ARP 414, and an RARP 416. While FIG. 4 shows the stack structure in which no FCSL exists between the MAC layer 320 (420) and the internetwork layer 310 (410), the FCSL may be present therebetween depending on a type of application.

When the first wireless network device 300 has data to transmit to the second wireless network device 400, the internetwork layer 310 transmits the data to the MAC layer 320 (\mathring{1}), which then generates an MAC frame containing the received data and provides the MAC frame to a PHY layer 330 ((\mathring{2})). In this case, the MAC layer 320 identifies a protocol of the internetwork layer 310 used to transmit data and specifies information identifying the type of data (“type information”) in the MAC frame according to the identified protocol.

The PHY layer 330 receiving the MAC frame from the MAC layer 320 generates a radio signal containing the MAC frame and transmits the radio signal to the second wireless network device 400 during channel time assigned to the first wireless network device 300 by a coordinator (not shown) (\mathring{3}).

A PHY layer 430 of the second wireless network device 400 receives the radio signal from the first wireless network device 300 (\mathring{4}), extracts the MAC frame from the radio signal, and transmits the MAC frame to an MAC layer 420 (\mathring{5}). In this case, the MAC layer 420 determines a protocol of the internetwork layer 410 to which data contained in the MAC frame will be transmitted by checking the type information specified in the MAC frame received from the PHY layer 430.

Once the protocol is determined, the MAC layer 420 transmits the data contained in the MAC frame to the protocol 412, 414, or 416 of the internetwork layer 410 (\mathring{6}).

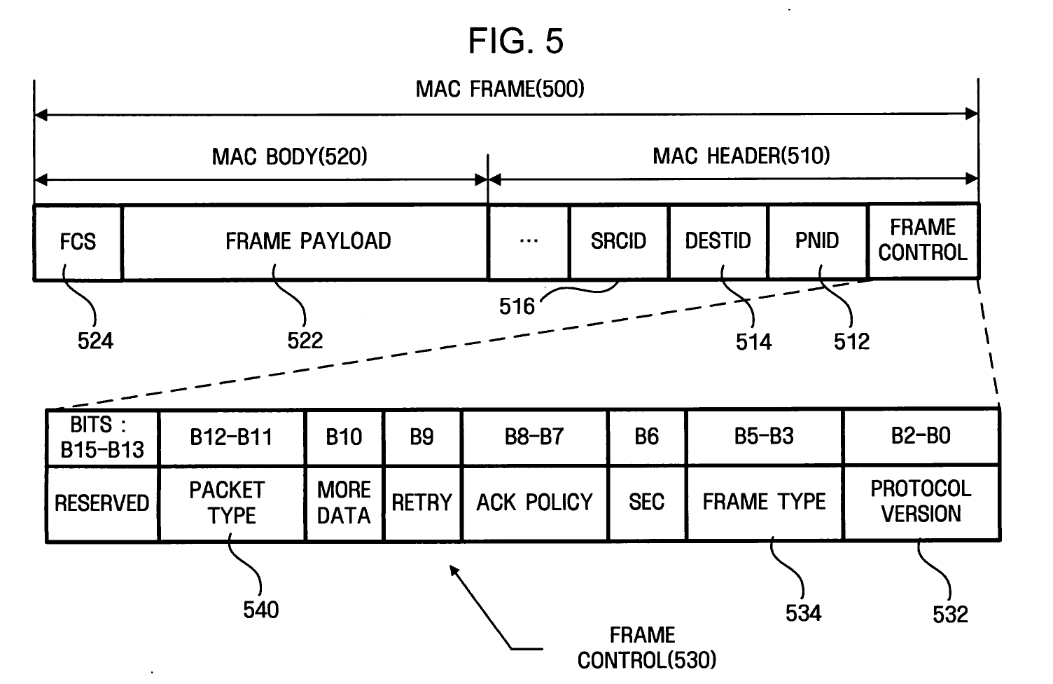

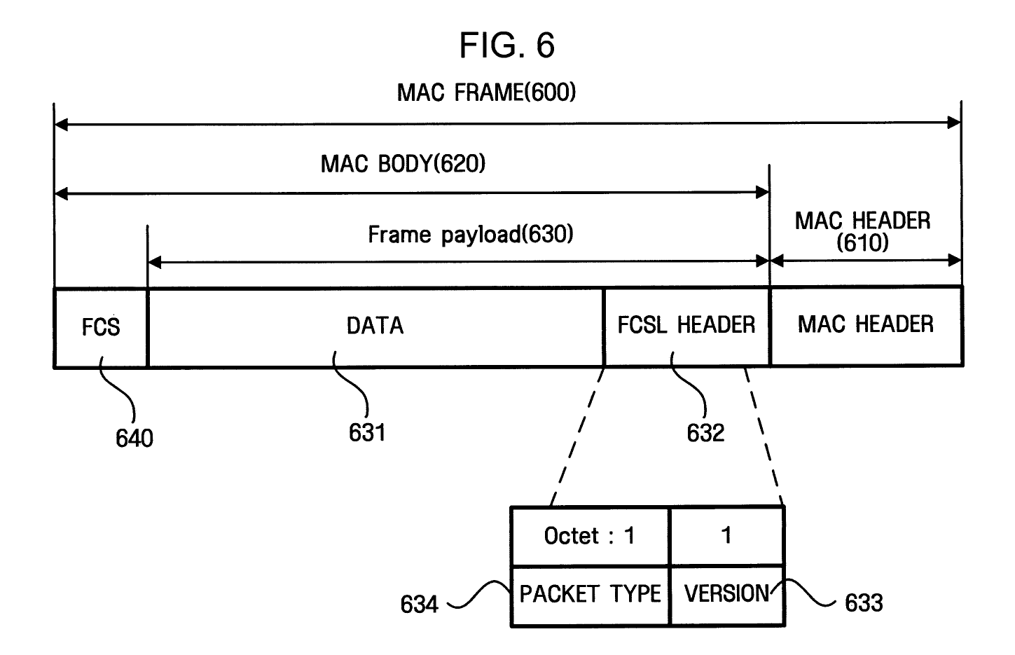

As described above, the type information is inserted into the MAC frame, thereby enabling inter-operation between the MAC layer and the layer above it. The type information can be specified in an MAC header or an MAC body. The format of an MAC frame according to exemplary embodiments of the present invention will now be described in detail with reference to FIGS. 5 and 6.

FIG. 5 illustrates the format of an MAC frame 500 according to an exemplary embodiment of the present invention.

The format of the MAC frame 500 conforms to the IEEE 802.15.3 standard.

The MAC frame 500 consists of an MAC header 510 and an MAC body 520.

The MAC body 520 includes a frame payload 522 containing data, i.e., a Protocol Data Unit (PDU) received from a layer above an MAC layer and a frame check sequence (FCS) field 524 used to determine a transmission error of the MAC frame 500.

For example, when an application layer is located above an MAC layer, the frame payload 522 contains application data.

Thus, when an internetwork layer is above the MAC layer as an exemplary embodiment of the present invention, the frame payload 522 contains an IP datagram, an ARP request/response, or RARP request/response. In this case, type information may be inserted in the MAC header 510 to identify the type of data contained in the frame payload 522.

The MAC header 510 includes a Piconet Identifier (PNID) information field indicating the ID of a piconet, an SrcID information field 516 identifying a device sending the MAC frame 500, and a DestID information field 514 identifying a target device receiving the MAC frame 500.

The MAC header 510 further includes a frame control field 530 indicating the properties of the MAC frame 500. The frame control field consists of the following subfields: a protocol version field 532 specifying information about an MAC protocol version, a frame type field 534 identifying the type of the MAC frame 500 (e.g., a beacon frame or an ACK frame), SEC, Ack policy, retry, and more data.

In addition to the above conventional fields, the frame control field includes a packet type field 540 defined using a reserved field. The packet type field 540 is used to indicate the type of data contained in the frame payload 522.

For example, when the internetwork layer is located above the MAC layer and the packet type field 540 is two bits in length, the packet type field 540 may be set to “00” if the frame payload 522 carries general type of data as defined in the conventional IEEE 802.15.3 standard. The packet type field 540 may be set to “01”, “10”, and “11” if the frame payload 522 carries an IP datagram, an ARP request/response, and an RARP request/response, respectively.

Thus, an MAC layer of a wireless network device sending data identifies a protocol of a layer situated above it, from which data is sent, and then specifies type information corresponding to the protocol of the upper layer in an MAC header. An MAC layer of a wireless network device receiving the MAC frame 500 uses the packet type field 540 in the MAC header 510 to identify a protocol that will be used to process data carried in the frame payload 522.

While FIG. 5 shows the packet type field 540 is two bits in length, one bit or three or more bits may be allocated for the packet type field 540.

Meanwhile, as the packet type field 540 is added to the IEEE 802.15.3 MAC header 500 to identify the type of data carried in the frame payload 522, a parameter for type information may be added to some messages defined in the IEEE 802.15.3 standard.

The structure of an MAC-ASYNC-DATA.request message as defined in the conventional IEEE 802.15.3 standard is modified as follows:

| | |
|---|---|
| MAC-ASYNC-DATA.request | ( |
| | PacketType |
| | TrgtID |
| | OrigID |
| | Priority |
| | ACKPolicy |
| | TransmissionTimeout |
| | Length |
| | Data |
| | ) |

The MAC layer complying with the IEEE 802.15.3 standard receives the MAC-ASYNC-DATA.request message from the Frame Convergence Sublayer (FCSL) and use it to determine a format of an MAC Protocol Data Unit (MPDU). In this case, among parameters forming the MAC-ASYNC-DATA.request message, PacketType is a parameter newly defined in the present invention, specifying information on the type of data received from an upper layer. The MAC layer is able to generate an MAC frame containing type information indicating type of data carried in a frame payload using the PacketType parameter.

Meanwhile, an MAC-ASYNC-DATA.indication message, which is a response message to the MAC-ASYNC-DATA.request message, can also be modified. The MAC-ASYNC-DATA.indication message modified according to the present invention is as follow:

| | |
|---|---|
| MAC-ASYNC-DATA.indication | ( |
| | PacketType |
| | TrgtID |
| | OrigID |
| | Length |
| | Data |
| | ) |

Among parameters forming the MAC-ASYNC-DATA.indication message, PacketType is a parameter newly defined in the present invention, specifying type information indicating type of data to be carried in an MAC frame payload, as described above in the MAC-ASYNC-DATA.request message. The MAC-ASYNC-DATA.request message can be generated by an MAC layer when an MAC Protocol Data Unit (MPDU) is successfully received by the MAC layer.

Meanwhile, the MAC-ASYNC-DATA.request message and the MAC-ASYNC-DATA.request message are messages for asynchronous data defined in the IEEE 802.15.3 standard. When an MAC layer generates an MAC frame for isochronous data, the MAC-ASYNC-DATA.request message and the MAC-ASYNC-DATA.indication message may be modified as follows:

| | |
|---|---|
| MAC-ISOCH-DATA.request( | |
| | PacketType |
| | StreamIndex |
| | TransmissionTimeout |
| | Length |
| | Data |
| | ) |
| MAC-ISOCH-DATA.indication | ( |
| | PacketType |
| | TrgtID |
| | OrigID |
| | StreamIndex |
| | Length |
| | Data |
| | ) |

Each of the respective messages contains PacketType parameter newly defined according to the present invention and the function thereof is the same as described above in the messages for asynchronous data.

Alternatively, type information of data provided from an upper layer may be specified in a body of an MAC frame.

FIG. 6 illustrates the format of an MAC frame 600 containing a body in which the type information is specified according to another exemplary embodiment of the present invention.

Referring to FIG. 6, the format of the MAC frame 600 conforms to the IEEE 802.15.3 standard.

The MAC frame 600 consists of an MAC header 610 and an MAC body 620.

The MAC header 610 is composed of the same fields as defined in the conventional IEEE 802.15.3 standard.

The MAC body 620 includes a frame payload 630 containing data (PDU) 631 received from a layer above an MAC layer of an IEEE 802.15.3 protocol suite and an FCSL header 632, and an FCS field 640 used to determine a transmission error of the MAC frame 600.

For example, when an application layer is located above an MAC layer, the data 631 included in the frame payload 622 may be application data.

Thus, when an internetwork layer is above the MAC layer, the data 631 carried in the frame payload 630 may contain an IP datagram, an ARP request/response, or an RARP request/response. In this case, type information may be inserted in the MAC header 632 to identify the type of the data 631 contained in the frame payload 630.

That is, in the present exemplary embodiment, when an FCSL receives data from its upper layer, the FCSL can provide the data and the FCSL header 632 containing type information of the data to the MAC layer.

The FCSL header 632 contains a version field 633 specifying information about its own version and a packet type field 634 specifying information about the type of the data 631 carried in the frame payload 630. Although the packet type field 634 has a one-octet length in the exemplary embodiment, it is to be understood that the illustration is merely illustrative of and not restriction of the invention.

For example, when the internetwork layer is located above the FCSL layer and the packet type field 634 is two bits in length, the packet type field 634 may be set to “00” if the frame payload 630 carries general type of data as defined in the conventional IEEE 802.15.3 standard. The packet type field 634 may be set to “01”, “10”, and “11” if the frame payload 630 carries an IP datagram, an ARP request/response, and an RARP request/response, respectively.

Thus, an FCSL layer of a wireless network device sending data identifies a protocol of a layer situated above it, from which data is sent, and then inserts an FCSL header containing type information corresponding to the protocol to data received from the upper layer. The data with the FCSL header is supplied to an MAC layer. The MAC layer adds an MAC header to the data received from the FCSL layer, that is, the data contained in the FCSL header, to then supply the same to a PHY layer.

In addition, the MAC layer and the FCSL of a wireless network device receiving the MAC frame 600 removes the MAC header 610 from the MAC frame 600 and uses the packet type field 634 in the FCSL header 632 to identify a protocol that will be used to process data 631 carried in the frame payload 630.

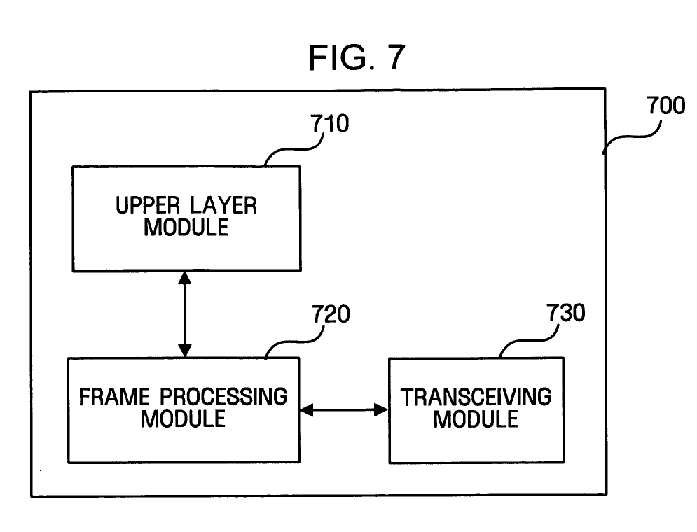

FIG. 7 is a block diagram of a wireless network device 700 according to an exemplary embodiment of the present invention.

The wireless network device 700 includes an upper layer module 710, a frame processing module 720, and a transceiving module 730.

The upper layer module 710 sends data to be transmitted to another wireless network device to the frame processing module 720 and receives data carried in an MAC frame transmitted from other wireless network device from the frame processing module 720. The upper layer module 710 manages network layers above a logical link control (LLC) layer. The layers managed by the upper layer module 710 may include an internetwork layer of the TCP/IP protocol suite.

The frame processing module 720 manages operation at the FCSL and MAC layers. That is, the frame processing module 720 that receives the data from the upper layer module 710 identifies a protocol of the upper layer module 710 providing the data. The frame processing module 720 then generates an MAC frame containing information about the type of data provided from the upper layer module 710 according to the protocol. The type information may be included in the MAC header or MAC body of the MAC frame. Examples of the MAC frame generated by the frame processing module 720 have been described above with reference to FIGS. 5 and 6.

In addition, the frame processing module 720 also reads an MAC header of an MAC frame received from the transceiving module 730, removes the MAC header from the MAC frame, and transmits the result to the upper layer module 710. In this case, the frame processing module 720 uses type information contained in the MAC header or MAC body (preferably, FCSL header) of the MAC frame to identify a protocol that will process data carried in a frame payload. Thus, the frame processing module 720 transmits data to the protocol identified through the type information among protocols of the layers managed by the upper layer module 710.

The MAC frame generated or received by the frame processing module 720 conforms to a protocol for a coordinator-based wireless network.

The transceiving module 730 manages operation at a PHY layer. That is, the transceiving module 730 generates a Packet Protocol Data Init (PPDU) containing a PHY header in addition to the MAC frame received from the frame processing module 720 and transmits a radio signal containing the PPDU through a wireless medium.

The transceiving module 730 extracts an MAC frame from the radio signal received via the wireless medium and transmits the MAC frame to the frame processing module 720.

The transceiving module 730 is subdivided into a baseband processor (not shown) and an RF module (not shown).

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

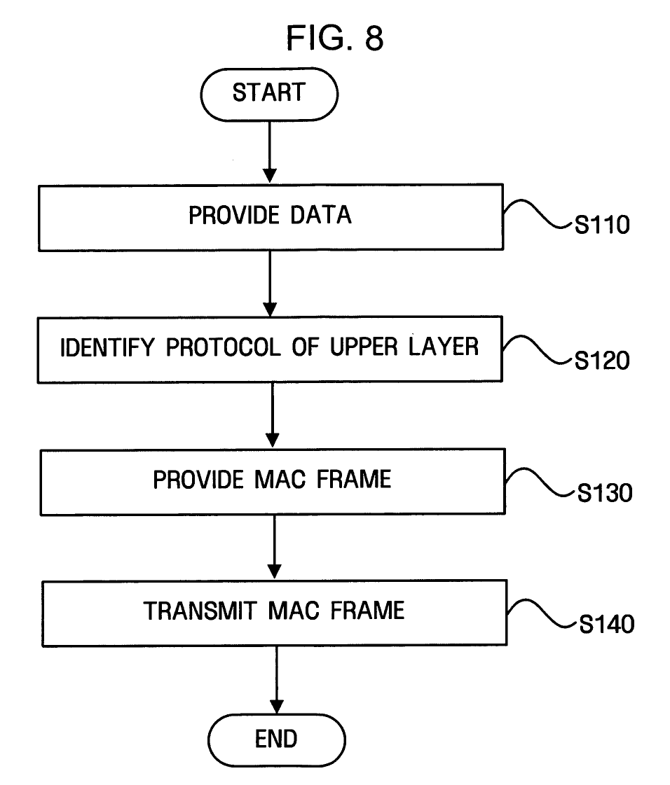

FIG. 8 is a flowchart illustrating a method for transmitting data in a coordinator-based wireless network according to an exemplary embodiment of the present invention.

Referring to FIGS. 7 and 8, in operation S110, the upper layer module 710 of the wireless network device having data to be transmitted to another wireless network device provides the data to the frame processing module 720.

In operation S120, the frame processing module 720 that receives the data from the upper layer module 710 identifies a protocol of a layer above an MAC layer used to transmit the data.

In operation S130, the frame processing module 720 then provides an MAC frame containing the data and type information of the data. The type information is set according to the protocol of the upper layer identified in the operation S120. Furthermore, the MAC frame provided in the operation S130 conforms to a protocol for a coordinator-based wireless network. Examples of the format of the MAC frame provided in the operation S130 have been shown and described with reference to FIGS. 5 and 6.

In operation S140, the transceiving module 730 sends the MAC frame provided by the frame processing module 720 to the other wireless network device. More specifically, the transceiving module 730 generates a radio signal containing the MAC frame and transmits the radio signal to the other wireless network device via a wireless medium.

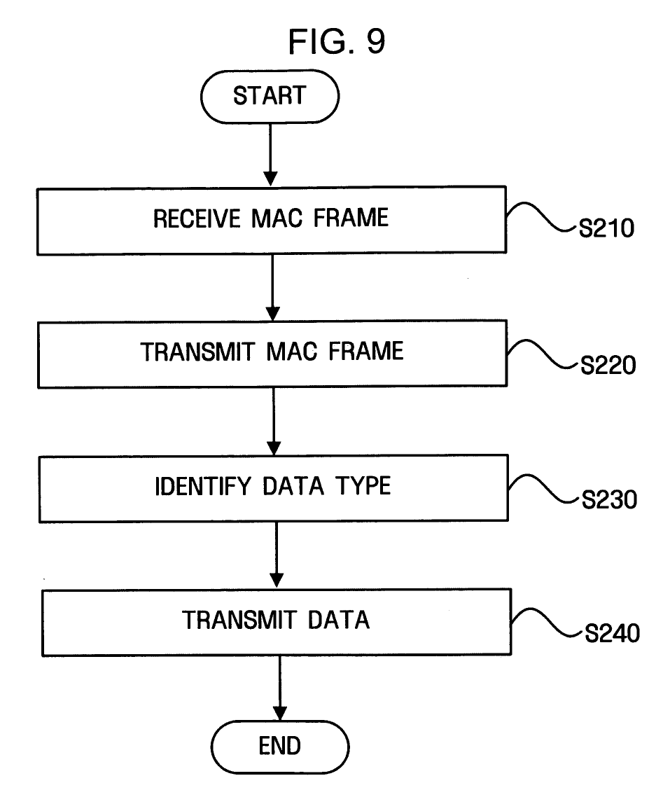

FIG. 9 is a flowchart illustrating a method for receiving data in a coordinator-based wireless network according to an exemplary embodiment of the present invention.

Referring to FIGS. 7 and 9, upon receiving an MAC frame from a coordinator-based wireless network in operation S210, the transceiving module 730 transmits the MAC frame to the frame processing module 720 in operation S220. The MAC frame conforms to a protocol for a coordinator-based wireless network. Examples of the format of the MAC frame have been shown and described with reference to FIGS. 5 and 6.

In operation S230, the frame processing module 720 that receives the MAC frame from the transceiving module 730 identifies the type of data contained in the MAC frame through type information inserted in the MAC frame. That is, the type information contained in the MAC header or MAC body (preferably, FCSL header) of the MAC frame to identify a protocol of an upper layer that will process the data contained in the MAC body.

Then, in operation S240, the frame processing module 720 transmits the data contained in the MAC frame to the upper layer module 710, more specifically, to the protocol of the upper layer identified in the operation S230 among upper layers managed by the upper layer module 710.

The present invention will be described hereinafter with reference to FIGS. 8 and 9, which are flowchart illustrations of methods according to exemplary embodiments of the invention. It will be understood that each block of the flowchart illustrations, and combinations of blocks in the flowchart illustrations, can be implemented by computer program instructions.

These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

A method for receiving data in a coordinator-based wireless network and a wireless network apparatus employing the same enable inter-operation between an MAC layer and a layer located above it in the coordinator-based wireless network by specifying type information in an MAC frame.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

1. A method for transmitting data in a coordinator-based wireless network, the method comprising:
providing data to be transmitted to a wireless network device in the coordinator-based wireless network;
providing a Media Access Control (MAC) frame containing the data and type information indicating a type of the data and conforming to a protocol for the coordinator-based wireless network; and
transmitting the MAC frame to the wireless network device via a wireless medium.

2. The method of claim 1, wherein the type information is contained in an MAC header of the MAC frame.

3. The method of claim 2, wherein the MAC frame is an IEEE 802.15.3 MAC frame and the type information is specified in a field of the MAC header reserved for future use.

4. The method of claim 1, wherein the type information is contained in an MAC body of the MAC frame.

5. The method of claim 4, wherein the MAC frame is an IEEE 802.15.3 MAC frame and the type information is specified in a Frame Convergence Sublayer (FCSL) header.

6. The method of claim 1, wherein the data is provided from an internetwork layer.

7. A method for receiving data in a coordinator-based wireless network, the method comprising:
receiving a Media Access Control (MAC) frame conforming to a protocol for the coordinator-based wireless network via a wireless medium in the coordinator-based wireless network;
checking type information representing a type of data contained in the MAC frame; and
providing the data to a protocol of a layer above an MAC layer, which is identified through the type information.

8. The method of claim 7, wherein the type information is contained in an MAC header of the MAC frame.

9. The method of claim 8, wherein the MAC frame is an IEEE 802.15.3 MAC frame and the type information is specified in a field of the MAC header reserved for future use.

10. The method of claim 7, wherein the type information is contained in an MAC body of the MAC frame.

11. The method of claim 10, wherein the MAC frame is an IEEE 802.15.3 MAC frame and the type information is specified in a Frame Convergence Sublayer (FCSL) header.

12. The method of claim 7, wherein the layer above the MAC layer is an internetwork layer.

13. A wireless network device comprising:
an upper layer module which provides data to be transmitted to another wireless network device in a coordinator-based wireless network;
a frame processing module which provides a Media Access Control (MAC) frame containing the data provided by the upper layer module and type information indicating a type of the data and conforming to a protocol for the coordinator-based wireless network; and
a transceiving module which transmits the MAC frame provided by the frame processing module through a wireless medium.

14. The wireless network device of claim 13, wherein the type information is contained in an MAC header of the MAC frame.

15. The wireless network device of claim 14, wherein the MAC frame is an IEEE 802.15.3 MAC frame and the type information is specified in a field of the MAC header reserved for future use.

16. The wireless network device of claim 13, wherein the type information is contained in an MAC body of the MAC frame.

17. The wireless network device of claim 16, wherein the MAC frame is an IEEE 802.15.3 MAC frame and the type information is specified in a Frame Convergence Sublayer (FCSL) header.

18. The wireless network device of claim 13, wherein the upper layer module manages an internetwork layer and the data is provided from the internetwork layer.

19. A wireless network device comprising:
a transceiving module which receives a Media Access Control (MAC) frame conforming to a protocol for a coordinator-based wireless network via a wireless medium in the coordinator-based wireless network; and
a frame processing module which checks type information representing a type of data contained in the MAC frame received by the transceiving module and provides the data to a protocol of a layer above an MAC layer, which is identified through the type information.

20. The wireless network device of claim 19, wherein the type information is contained in an MAC header of the MAC frame.

21. The wireless network device of claim 20, wherein the MAC frame is an IEEE 802.15.3 MAC frame and the type information is specified in a field of the MAC header reserved for future use.

22. The wireless network device of claim 19, wherein the type information is contained in an MAC body of the MAC frame.

23. The wireless network device of claim 22, wherein the MAC frame is an IEEE 802.15.3 MAC frame and the type information is specified in a Frame Convergence Sublayer (FCSL) header.

24. The wireless network device of claim 19, wherein the layer above the MAC layer is an internetwork layer.
